(19) United States
(12) Patent Application Publication
(10) Pub. No.: US 2025/0277555 A1
(43) Pub. Date: Sep. 4, 2025

(54) Pipeline Inspection Robot

(71) Applicant: Board of Trustees of Michigan State University, East Lansing, MI (US)

(72) Inventors: Xiaobo TAN, Okemos, MI (US); Preston FAIRCHILD, East Lansing, MI (US); Claudia CHEN, Canton, MI (US); Yiming DENG, Okemos, MI (US); Mohand ALZUHIRI, Diyala (IQ); Zhi LI, Bloomfield Hills, MI (US); Xinda QI, Malden, MA (US)

(73) Assignee: Board of Trustees of Michigan State University, East Lansing, MI (US)

(21) Appl. No.: 19/066,658

(22) Filed: Feb. 28, 2025

Related U.S. Application Data
(60) Provisional application No. 63/560,908, filed on Mar. 4, 2024.

(51) Int. Cl. F16L 55/40; F16L 55/48; F16L 101/30; G06T 7/00; G06T 7/73; H04N 7/18

(52) U.S. Cl. CPC F16L 55/40; F16L 55/48; G06T 7/0002; G06T 7/73; H04N 7/185; F16L 2101/30; G06T 2207/30261

(57) ABSTRACT

A robot apparatus, including elongated segments connected by joints and having wheels, is configured to move along an elongated enclosure. Another aspect of the robot provides multiple articulated rail segments, each pair connected by pivotable joints, with a linear biasing member such as a tension spring spanning across each joint, configured to laterally urge wheels adjacent to the joints to contact opposite internal walls of a pipe. A further aspect of the present robot provides articulated segments, actuators mounted thereto, wheels independently driven by the actuators, and a programmable controller movable with the segments for causing autonomous advancing and retracting movement, maneuvering and/or steering of the robot within an elongated conduit or pipe, while optically and/or visually sensing and inspecting deterioration and irregularities, such as cracks and deformation, in the conduit or pipe. A selectively bendable sub-joint, connected between nominally aligned segments of a rigid rail, is also optionally employed.

### CROSS-REFERENCE TO RELATED APPLICATION

The present application claims priority to provisional patent application Ser. No. 63/560,908, filed on Mar. 4, 2024, which is incorporated by reference herein.

### GOVERNMENT SUPPORT

This invention was made with government support under grant 693JK32050002CAAP awarded by the Department of Transportation, Pipeline and Hazardous Material Safety Administration (PHMSA), and under grant 2222635 awarded by the National Science Foundation. The government has certain rights in the invention.

### BACKGROUND AND SUMMARY

The present application generally pertains to robots and more particularly to pipeline inspection robots.

Polymeric underground pipes are becoming more common. However, these materials are more susceptible to damage due to nearby excavation or environmental stresses. This may lead to undesirable pipe fractures or collapsing, which may cause clogging or leakage. Therefore, detection and identification of underground pipe deterioration is desired.

Remote controlled robots are known. For example, a commonly owned robot with sensors is disclosed in U.S. Patent Publication No. 2023/0191861, entitled “Amphibious Snake Robot” which published to Tan, et al., on Jun. 22, 2023. In another commonly owned application, sensors and algorithms for pipe inspection are disclosed in U.S. Patent Publication No. 2024/0077426 (application Ser. No. 18/238,502) entitled “Light-Based Inspection Tools for the Inspection of the Internal Surface of a Cylindrical Structure” which was invented by Yiming Deng, et al., and filed on Aug. 27, 2023. Both of these patent applications are incorporated by reference herein. While these provide significant advances in the field, additional improvements are desired.

One conventional approach is discussed in Kakogawa, A., et al., “A Multi-Link In-Pipe Inspection Robot Composed of Active and Passive Compliant Joints,” IEEE/RSJ International Conference on Intelligent Robots and Systems (IROS) (Oct. 25-29, 2020). Another tradition construction is discussed in Kakogawa, A., et al., “Automatic T-Branch Travel of an Articulated Wheeled In-Pipe Inspection Robot Using Joint Angle Response to Environmental Changes,” IEEE Transactions on Industrial Electronics, vol. 70, No. 7 (July 2023). These devices employ an in-pipe inspection robot having multiple wheeled joints with a polyurethane rubber or wound metal torsion spring inside each joint, which undesirably increases the lateral width of the robot. Moreover, the motors are laterally oriented adjacent to each joint, which further increases the lateral width of the robot. A cable tether is shown for the robot in these publications.

In accordance with the present invention, a robot apparatus, including elongated segments connected by joints and having wheels, is configured to move along an elongated enclosure. Another aspect of the robot provides multiple articulated rail segments, each pair connected by pivotable joints, with a linear biasing member such as a tension spring spanning across each joint, configured to laterally urge wheels adjacent to the joints to contact opposite internal walls of a pipe. A further aspect of the present robot provides articulated segments, actuators mounted thereto, wheels independently driven by the actuators, and a programmable controller movable with the segments for causing autonomous advancing and retracting movement, maneuvering and/or steering of the robot within an elongated conduit or pipe, while optically and/or visually sensing and inspecting deterioration and irregularities, such as cracks and deformation, in the conduit or pipe. In yet another aspect, the present robot employs a linear spring between jointed segments to bias the segments in a laterally radial direction so that oppositely oriented wheels compress, thus, outwardly heightening the robot against opposite internal wall surfaces of a conduit or pipe while the robot travels therealong. Still another aspect includes an untethered robot, a structured light sensor coupled to the robot and mapping, IMU-assisted data registration and reconstruction algorithms and software used for analyzing data sensed by the sensor. Methods of manufacturing and/or using an autonomously movable robot to inspect and sense deterioration and irregularities in a conduit or pipe, are also provided.

The present apparatus and method are advantageous over conventional systems. For example, the present robot is ideally suited for traveling within different internal diameter pipes or pipes having varying internal diameters, such as those of 4-10 inch internal diameter, and more preferably small diameters of 8 inches or less. The present robot is advantageously movable up or down inclined pipes up to about 45°.

The spring biased radial and folding outward compression of opposite wheels against opposing surfaces of the pipe, allow for beneficial friction of the wheels-to-pipe which is sufficient to longitudinally move the robot even in wet or slime-covered pipe conditions. The autonomous and untethered nature of the present robot advantageously allows the robot to move very long distances and underground, while the onboard controller automatically maps the pipe interior and detects if a undesired surface condition (such as deterioration or irregularity) is present and if so, where, without the need for constant back and forth external communications and control (although such external communications is optional if the pipe is above-ground). The optional ability to bend or offset sub-joints within a rail segment, such as through use of the temporary heat-deformation of a joint material, allows the robot to transform into a smaller lateral size in order to navigate around or across large internal obstructions or to steer around tight pipe turns. Moreover, the present mapping, IMU-assisted data registration and reconstruction algorithms and software advantageously improve alignment data in all directions, which leads to enhanced pipe inspection quality. Additional features and benefits will be further described herein with reference to the following specification and appending drawings.

### BRIEF DESCRIPTION OF THE DRAWINGS

FIG. 1 is a perspective view showing the present pipeline inspection robot;

FIG. 2 is a fragmentary and partially exploded, perspective view showing an intermediate joint hub of the present pipeline inspection robot;

FIG. 3 is a perspective view showing a servo and structured light sensor of the present pipeline inspection robot;

FIG. 4 is an electrical circuit diagram of the present pipeline inspection robot;

FIGS. 5 and 6 are side perspective views showing the present pipeline inspection robot in different movement orientations within a pipe;

FIG. 7 is an end elevation view showing the present pipeline inspection robot within the pipe;

FIG. 8 is an elevation view showing the present pipeline inspection robot partially within the pipe and its camera-sensed internal pipe image on a computer;

FIG. 9 is an enlarged view showing the camera-sensed internal pipe image and a computer reconstruction thereof;

FIGS. 10 and 11 are perspective views showing an optional sub-joint configuration of the present pipeline inspection robot, in different movement orientations;

FIG. 12 is a partially exploded, perspective view showing the optional sub-joint configuration of the present pipeline inspection robot;

FIG. 13 is a software logic diagram for the present pipeline inspection robot;

FIG. 14 is a perspective view showing the present pipeline inspection robot in a compressed W-shaped orientation;

FIG. 15 is a side elevation view showing the present pipeline inspection robot;

FIG. 16 is an end elevation view showing the present pipeline inspection robot;

FIG. 17 is a cross-sectional view, taken along line 17-17 from FIG. 16, showing the present pipeline inspection robot;

FIG. 18 is a cross-sectional view, taken along line 18-18 from FIG. 15, showing the present pipeline inspection robot;

FIG. 19 is a partially exploded, perspective view showing the present pipeline inspection robot;

FIG. 20 is a more detailed robot operation control and software logic diagram for the present pipeline inspection robot; and

FIG. 21 is a series of diagrammatic views showing movement of the present pipeline inspection robot around a bend in the pipe.

### DETAILED DESCRIPTION

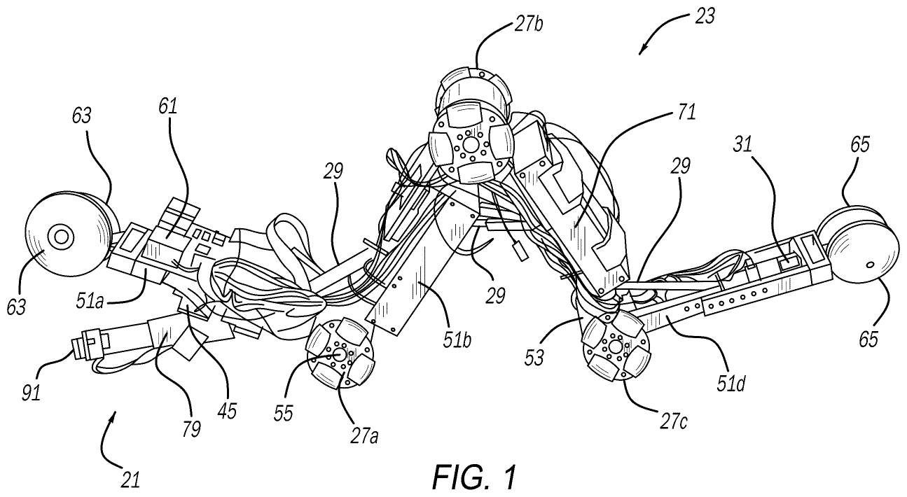

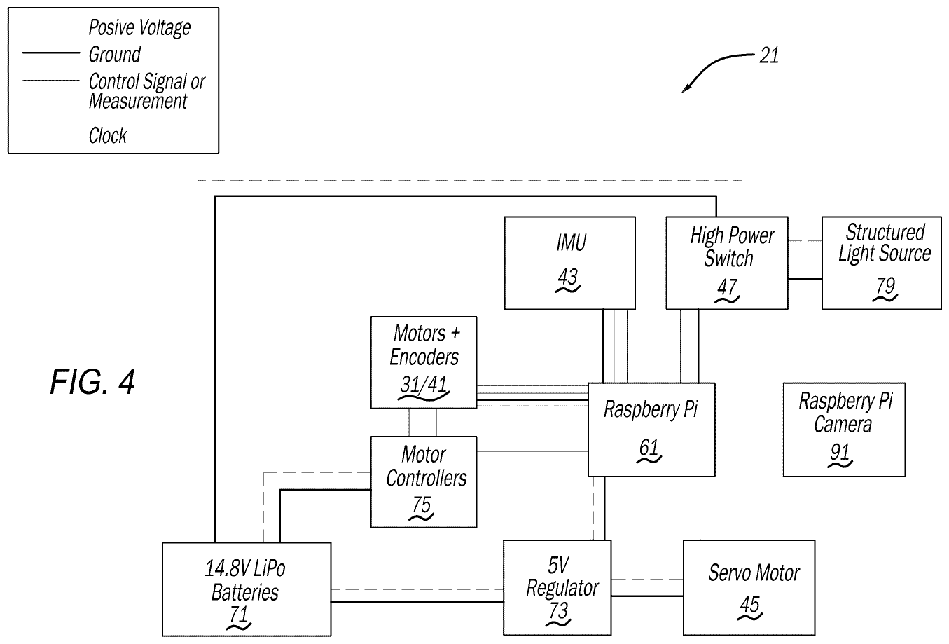

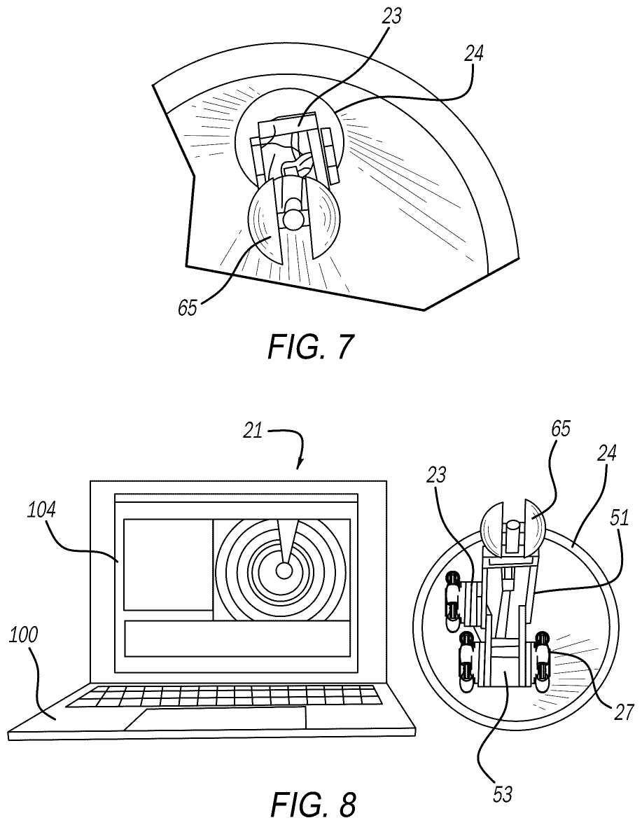

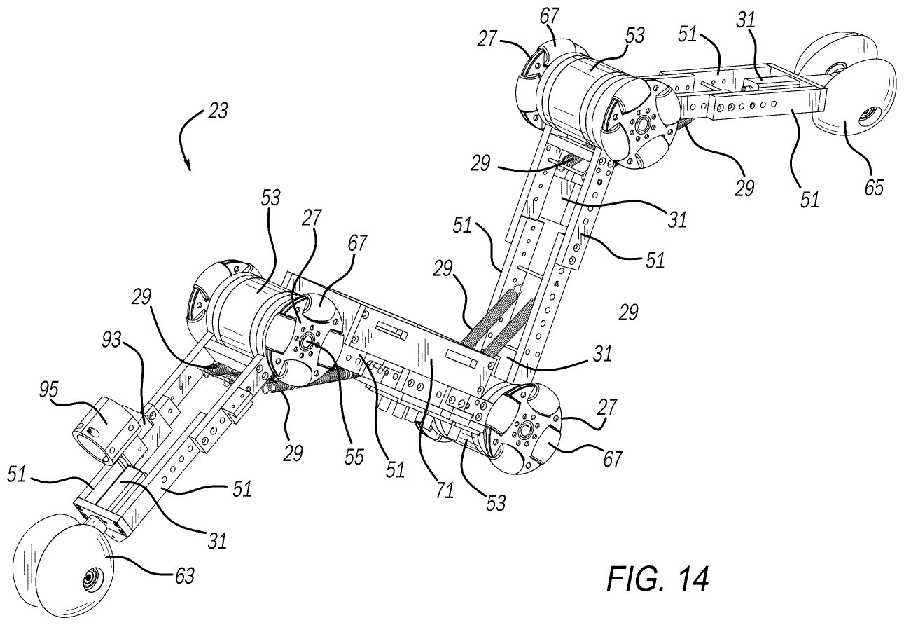

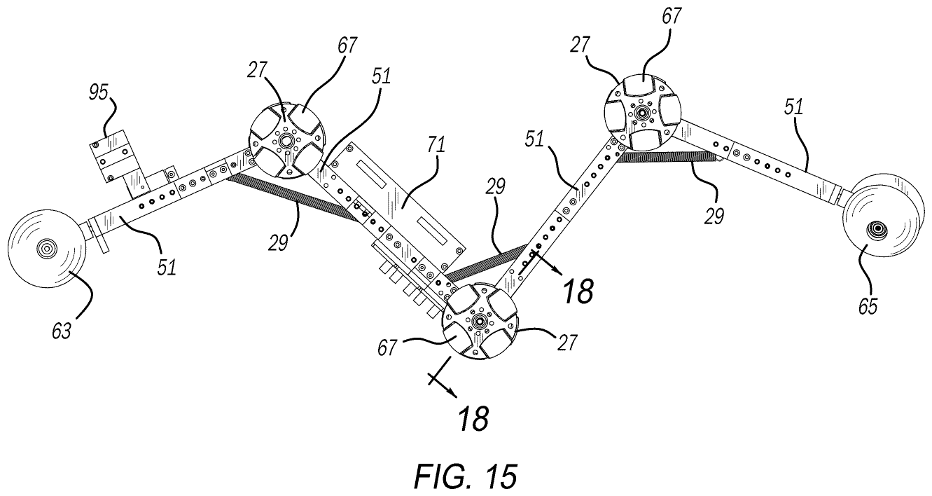

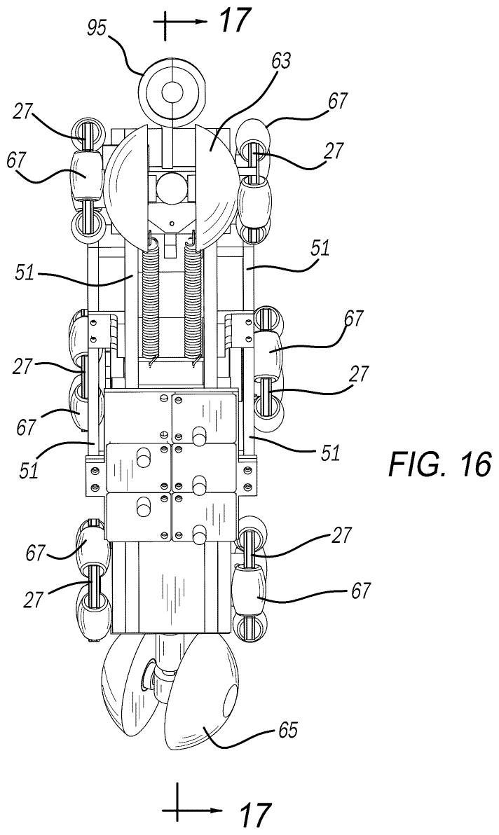

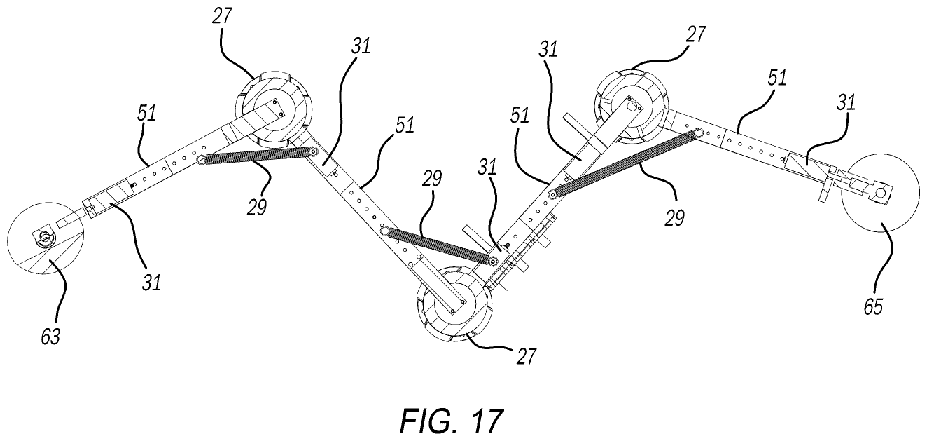

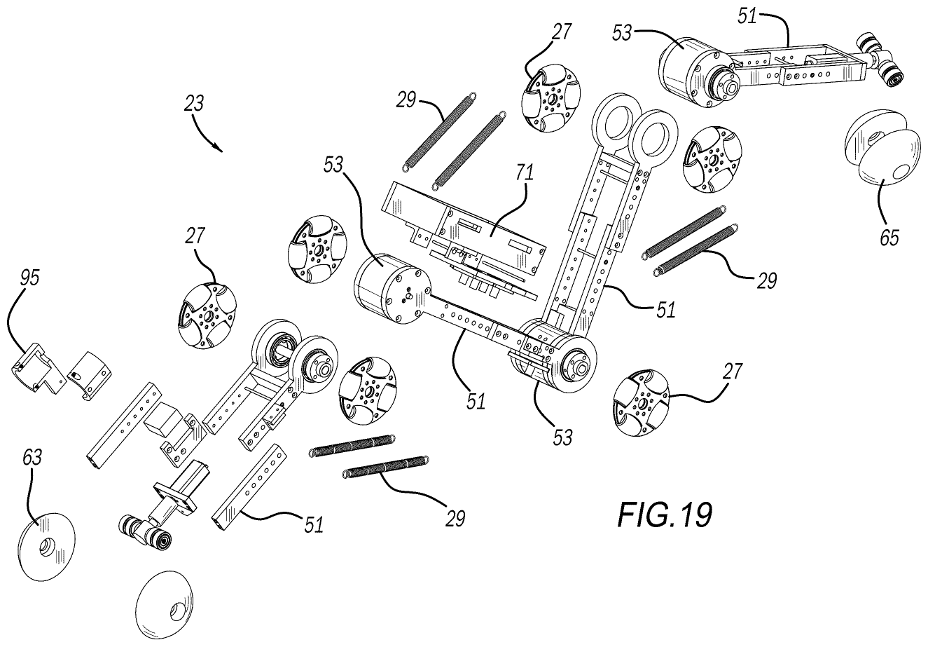

Referring to FIGS. 1-8 and 14-19, a preferred embodiment of a robot apparatus 21 includes a pipeline inspection robot 23, which is a robotic platform designed to transport and operate sensors inside a pipeline environment to collect data on conditions such as defects 25 and damages in pipe 24. The platform itself is a snake-like robot that uses sets of motorized wheels 27a-c for propulsion inside the pipeline. A set of springs 29 are used to keep compression for suitable contact and torque, to allow the robot to work in pipes of different diameters and enable extra actuation in the form of rotation inside the pipe. The robot is an untethered, battery-powered system supporting its own computational devices and power source. Actuators, preferably DC electric motors 31, include encoders 41 for position and velocity estimates of the robot's locomotion. The robot supports additional features for integration with sensors such as an inertial measurement unit (“IMU”) 43 for acceleration and angular positioning measurements, a servo motor 45 for orientation control and angulation of the structured light sensor, and high frequency switches 47 for large power demands. The robot features several important distinctions from traditional multi-linked robots, including an optional novel reconfigurable joint concept in an alternate embodiment, for enabling the robot to morph and maneuver through obstructions or tight turns in pipeline environments, as will be discussed in greater detail later.

Robot 23 includes four sets of longitudinally elongated rails 51a-d, each set having parallel left and right rails connected together at ends thereof. An open gap or space is disposed between the left and right rails, within which motors 31 and other components may be mounted. Each set of rails 51 are attached to hubs or joints 53, which allow rotation of adjacent rail sets relative to each other about a pivot axis 55 of each joint.

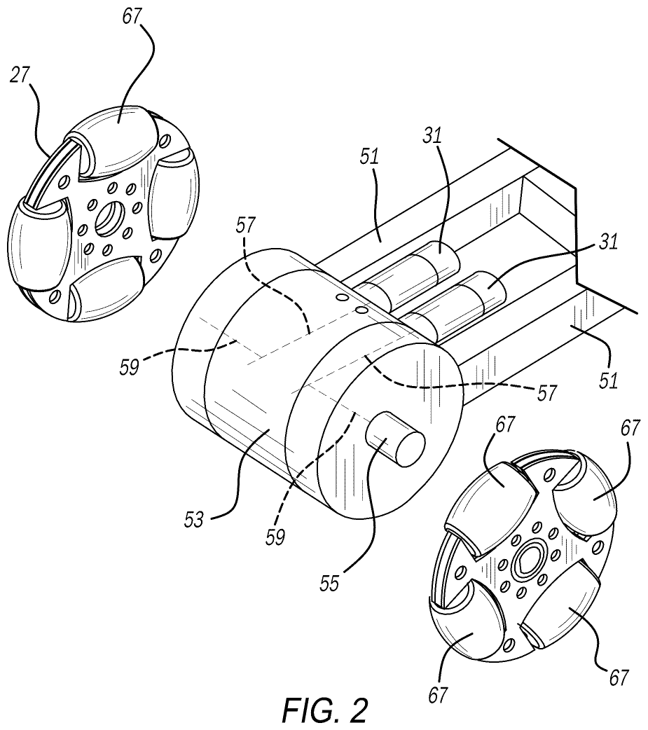

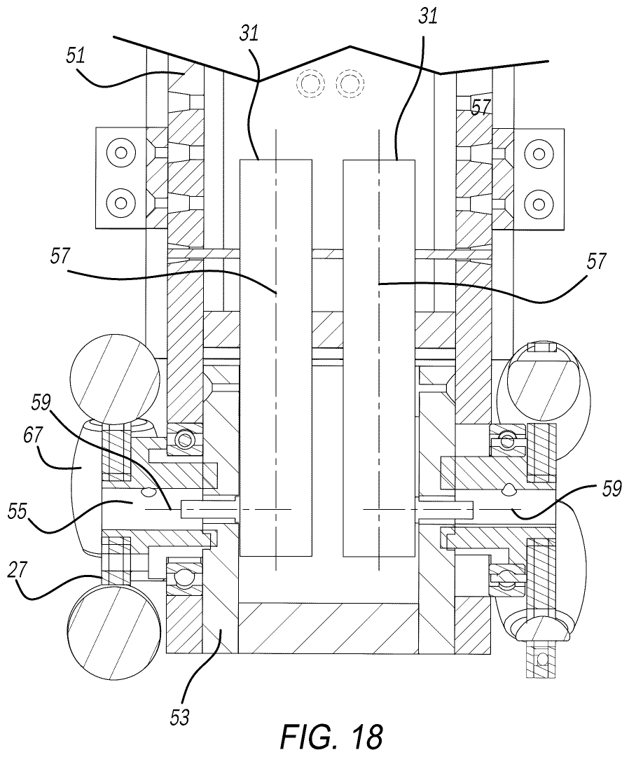

As can be observed in FIGS. 2 and 18, each wheel 27 is coupled to its own pivot pin 55 for rotation within each joint, regardless of the adjacent rail orientations. Each driving wheel 27 is preferably a circular and rotatable flat plate, although alternate external convex or spherical shapes may be used. Each pivot pin 55 is driven by an N20 DC electric motor 31, to which is coupled a rotational position encoder. Each motor 31 is at least partially located between the associated left and right rails, with a pair of the motors 31 being substantially parallel to each other, such that a longitudinally elongated axis 57 of an electromagnetically rotating armature of each is parallel to the adjacent rail 51 and generally perpendicular to a lateral axis 59 of pivot pins 55 associated with that joint 53. This beneficially provides very laterally compact packaging and protection of the motor. An output gear connected to an end of the motor armature, drives an enmeshed gear coupled to associated pivot pin 55, although optional additional or different gearing may be employed.

The middle six motors 31 drive wheel sets 27a-c to cause forward and backward directional movement of robot 23 inside pipeline 24, when an onboard programmable controller 61 energizes the motors. Similar motors 31 are longitudinally oriented within leading and trailing rails 51a and 51d, and these motors drive pairs of hemispherical end wheels 63 and 65, respectively, about their pivot pins. These eight motors 31 are preferably connected to PPR magnetic encoders 41 and are geared down at a ratio of 603:1, by way of nonlimiting example. This provides for a very high positional resolution on the rotation of the output shaft of the motor. Hemispherical end wheels 63 and 65 advantageously provide the necessary torque to achieve rotation inside the pipe.

Each driving wheel 27 has smaller wheels or omni-rollers 67 attached to peripheral edges thereof that reduce the amount of torque required to rotate the robot inside the pipeline. A rotational axis of each omni-roller 67 is generally perpendicularly offset from laterally oriented pivot axis 59. There are preferably four or five omni-rollers on each driving wheel.

A linear biasing member, such as helically coiled tension spring 29, has its looped or hooked ends removably coupled to intermediate surfaces of adjacent of the rails 27. Spring 29 externally spans across the adjacent joint 53. Therefore, each spring 29 pulls an adjacent pair of the rails to which it is coupled, toward each other in a laterally expanded manner with the rails being diagonally elongated with the joints and associated driving wheels both laterally and longitudinally spaced apart from each other. This creates a generally W or zig-zag configuration with the four rail segments, when the robot is in a nominal, compressed and collapsed state. The positioning of the linear biasing springs 29 outside of the joints advantageously allows more compact and smaller size for the joint, which in turn, allows the present robot to fit into smaller diameter pipes.

The robotic platform consists of at least the following electronic parts:
programmable controller 61, for example, a Raspberry Pi 4B as the main computational device, connected on a printed circuit board which is within a sealed enclosure mounted to a set of rails 51a;
14.8V LiPo 1550 mAh batteries 71 for power, mounted to a set of rails 51c;
a voltage regulator 73 for power distribution, on the circuit board;
N20 motors 31 with encoders 41 for movement and position/velocity estimation;
motor drivers or controllers 75 for controlling motors 31;
high frequency switches 47 for operating sensors 79; and
servo motor 45 and IMU 43 for orientation control of sensors 79.

A set of programs used to control the robotic platform were developed and integrated into the system. This includes python programs to control the actuation of the motors and servos as well as read sensor data. Also developed were C++ programs for integration with the structured light sensor. The programs include software instructions stored in non-transient RAM or ROM memory and run by the programmable controller for controlling automated movement of the robot (such as autonomous forward and backward driving within the pipe), automated sensing and determinations being made with regard to location of the robot within the pipe and recognizing pipe defects, pipe irregularities, obstructions and clogs within the pipe, and/or intersections and junctions within the pipe, and transmitting same for either onboard or remote automatic virtual recreation and display of the internal pipe images.

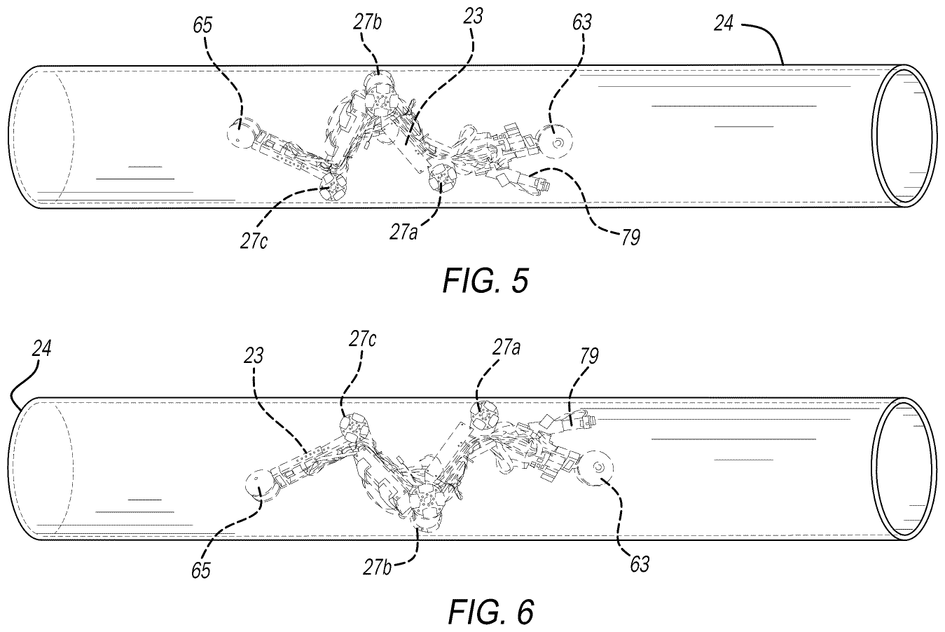

The robotic platform is categorized into the group of robots called snake-like pipeline inspection robots. In use, drive wheels 27a-c of the present robot 23 are laterally pressed into contact with opposing internal edge surfaces of pipe 24 in order to drive. Linear springs 29 pull the robot together into a laterally taller configuration by default. This interaction can best be observed in FIGS. 5-8 and 14-17.

This robot-to-pipe engagement serves two purposes: one is to put pressure on the wheels to increase their traction and the other is to compress the robot to fit the diameter of the pipe while allowing it to longitudinally stretch to fit inside smaller pipes. For example, a smaller diameter pipe may branch off of a larger diameter main pipe, with an intersection therebetween. The set of three inside wheels 27a-c are used for the forward and backward movement of the robot inside the pipeline. The additional set of two wheels 63 and 65 on the two ends of the robot may alternately be free spinning (i.e., not driven by motors), but the entire spherical end can be rotated against the pipe to produce rotation of the robot inside the pipe. By using this rotation and ensuring contact with multiple sides of the pipe, the robot is able to maneuver in common pipe joints such as T and Y-intersections. This causes either autonomous or remotely controlled steering whereby it allows the robot to navigate and choose which direction to travel inside the pipeline.

The present robot 23 and method are beneficial over traditional pipeline inspection robots, by the inclusion of certain unique and distinguishing features (which may be employed separately or in any combination), such as:
1. The implementation of linear springs 29 for contact pressure and compression. Other robots either use rotational torsion springs or an active servo motor control system for this purpose. This design provides the following benefits:
   a. Reduces the space taken up inside the joints of the robot. Torsion springs and servo motors are large and need to be placed at the point of rotation. Linear springs can be placed outside of the joints at multiple locations along the connections between them. This allows for more mechanical parts to be inside the joints.
   b. Linear springs are easy to access and do not require taking apart any structural pieces. This allows for easy alteration of the number of springs and their strength. Easier servicing and replacement of linear tension springs 29 is also achieved with the present robot.
   c. Linear springs are overall a cheaper alternative to torsion springs or servo motor control.
2. The addition of individually controlled joint wheels 27. Due to the extra space saved from the linear springs, the set of two joint wheels per joint 53 are able to be controlled by individual motors 31 as opposed to either a single wheel or all of the driving wheels being coupled to a single motor. This allows for additional control of the robot and increased complexity in the maneuvering inside the pipeline by implementing different speeds or opposite direction rotation of the wheels.
3. The implementation of a completely untethered platform. The robotic platform has its own computational source in the form of a raspberry Pi, that is capable of running software and controlling the robot as well as gathering data. Onboard batteries 71 provide all the necessary power to run the robotic platform for an extended period of time without over encumbering the robot.

The function of the pipeline inspection robot with the structured light sensor will now be discussed with regard to FIGS. 1, 3, 5-9 and 13-20. First, the robot utilizes three different sensors in its operations, although additional sensors may be employed:
1. Inertial Measurement Unit 43 with an accelerometer and a gyroscope;
2. wheel odometry from encoders 41 on motors 31; and
3. structured light sensor 79 and a camera 91.

The IMU and wheel odometry sensors are utilized for local positioning and corresponding tasks such as slippage detection. The accelerometer can give a rough estimate of the velocity of the robotic platform, while the wheel odometry is used to count the number of rotations of the wheels. Using these two sensors, the onboard programmable control automatically determines an estimate of the distance traveled from a starting reference point (aka dead reckoning). By examining anomalies between the two sensors, the onboard programmable controller automatically detects and determines situations where the robot may be stuck within the pipe, such as slipping where the IMU would estimate a velocity of 0, but the wheel odometry is steadily increasing, indicating the wheels are spinning but not propelling the robot forward, or when both the velocity and wheel odometry are 0, indicating the robot is stuck. This software control logic is as follows:
If change in wheel odometry=0 and velocity=0, the robot is stuck;
If change in wheel odometry>0 and velocity=0, the robot wheels are slipping;
If change in wheel odometry>0 and velocity>0, the robot is moving forward as normal.

Servo motor actuator 45 and its associated bracketry 93 couple structured light sensor 79 and camera 91 to rails 51a adjacent a leading end of robot 23. A clamping collar 95 holds SL sensor 79 with a pad therebetween to minimize vibrations. An LED light, lenses and a colored slide assembly 97 act with SL sensor 79 to produce structured light shapes. A white LED light 99 is adjacent camera 91 to illuminate the pipe interior for operator viewing and videos or photographic image capture thereof.

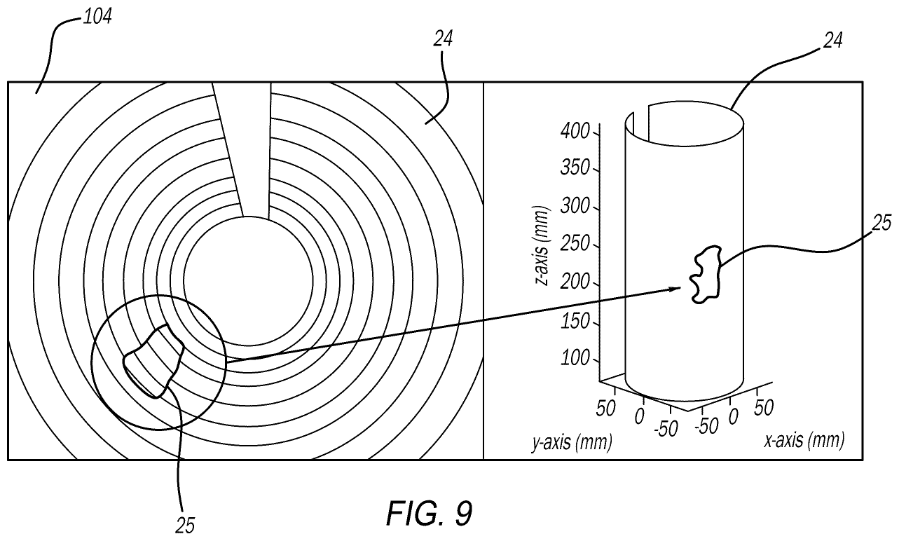

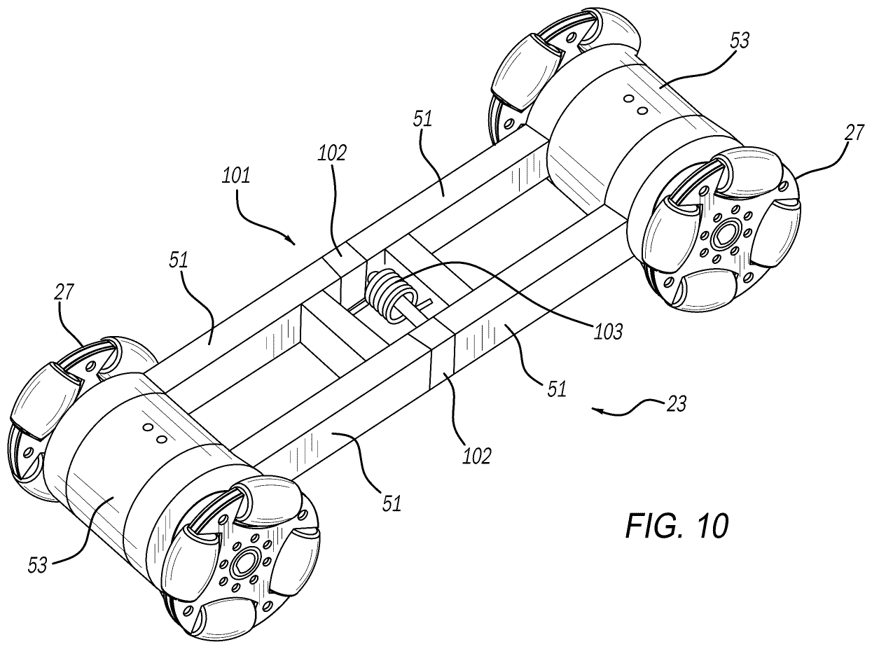

Structured light sensor 79 is the primary sensor on the robotic platform. Using camera 91 with the structured light, software instructions run by the onboard programmable controller 61 and/or a remotely located programmable controller/computer 100 in communication with the onboard controller, may automatically create a local reconstruction of the pipe currently visually observed by the camera. This software reconstruction image display can be observed in the right image of FIG. 9 based on the sensed structured light rings on the left image of FIGS. 8 and 9, which shows the defect irregularity 25 within pipe 24. The camera image and reconstructed image are visually shown on a display monitor 104 connected to remote controller 100. This allows for estimation of features of the pipe such as the inner pipe diameter, if there are any obstacles or obstructions inside the pipe that may be present, curves inside the pipe, or the presence and shape of intersections in the pipe. Another possible feature that can be observed is internal coupling between joints of two connecting pipes, which are usually a certain length apart.

Using these features, along with the dead reckoning from the IMU and wheel odometry, the onboard controller and its software convert any local positional estimations into a global positional estimation. That is to say, features in the pipe can be utilized to automatically update the reference position of the dead reckoning to reduce to accumulated error over time associated with it. With the global positioning estimation, the local pipe reconstruction can then be transformed into the global frame, and be appending to the data collected throughout operation. Accordingly, the onboard and/or remote controller and its software automatically generate and later display a map of the pipeline and update the map as new data is gathered. This is especially advantageous for underground pipes that may span hundreds of meters with branching sub-pipes, that were never mapped upon installation, and cannot easily access GPS information while underground.

Higher level trajectory planning can be determined by the controller and its software using the map it generates of the pipeline. By identifying features in the pipe such as the obstacles, curves and intersections, the onboard controller can better plan how it will navigate through these features. This is used through the methods the robot has to move: (a) forward and backward locomotion motors; (b) end wheel motors used for rotation of the robot to control its orientation inside the pipe; and (c) subjoint pivoting as will be discussed later.

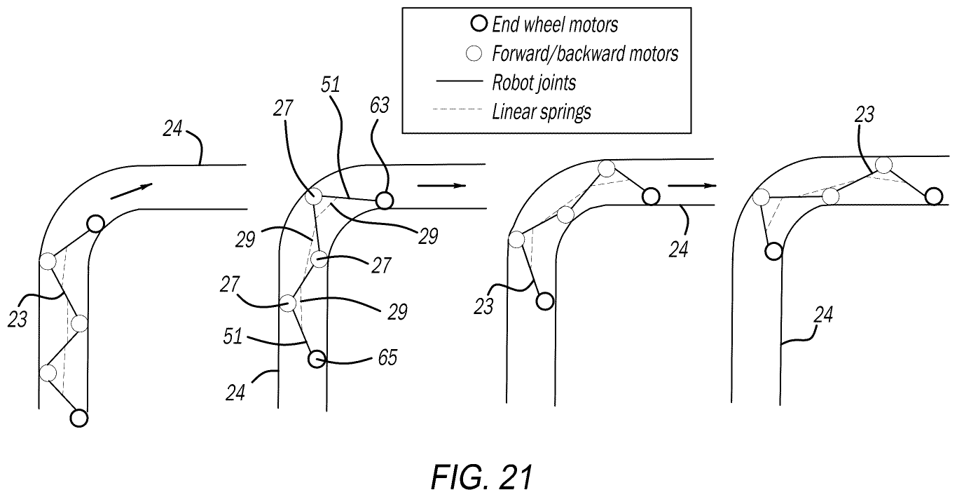

The rotational motors can be used to prepare the robot to navigate through curves or to select and specific direction to take through an intersection. The general idea is to rotate the robot such that leading front wheels 63 will be pressed against the closer pipe wall by its linear spring 29. This allows the robot to push itself through intersection or curves, as can be seen in the movement sequence of FIG. 21.

The map of the pipeline, as well as the path planning, feeds into a high-level mission planner software module, which attempts to accomplish the overall task of the robotic platform which may be to map the pipeline, search for blockages in the pipe, look for defects in the pipe walls, or other tasks. This feeds back into the trajectory planner software to then explore unknown areas of the pipeline, or to focus on higher detailed mapping of specific areas of interest.

The mapping, IMU-assisted data registration and reconstruction algorithms and software programmed instructions, are stored in non-transient RAM or ROM memory, and operate on onboard microprocessor controller 61 movable with the robot, and/or operate offline on a remotely located computer controller configured to receive downloaded data communicated from the robot-onboard controller after the inspection. More specifically, the IMU-assisted robotic structured light (SL) sensing system software and algorithms are distinguishing from other pipe inspections through at least the following distinctive features.

Random sample consensus (“RANSAC”)-assisted cylindrical fitting-based registration for sensor stabilization: The method performs cylindrical fitting while iteratively isolating defects by using RANSAC to have accurate estimation of the surface orientation.
a. Instead of a direct matching of the point clouds, the present registration algorithm exploits the geometry of the pipe and certain sensor characteristics to enable accurate registration even in the presence of defects.
b. This approach is preferred over features-based localization because it provides relatively accurate location and orientation estimation even when visual features (defects) are absent, which is common in plastic gas pipelines.
c. The present registration algorithm has greater reliability in defect reconstruction and robustness to baseline shifts. It excels in retrieving a more accurate pipe shape with a clearer and smoother boundary.

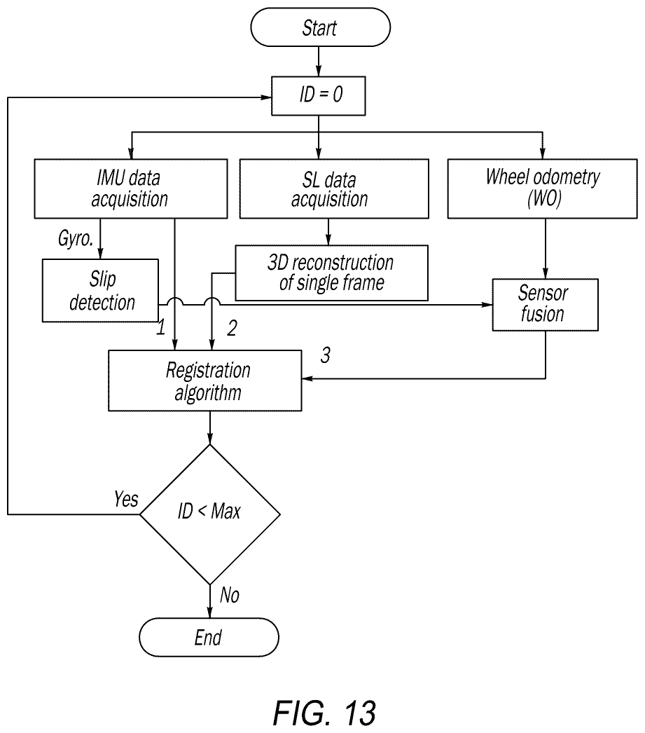

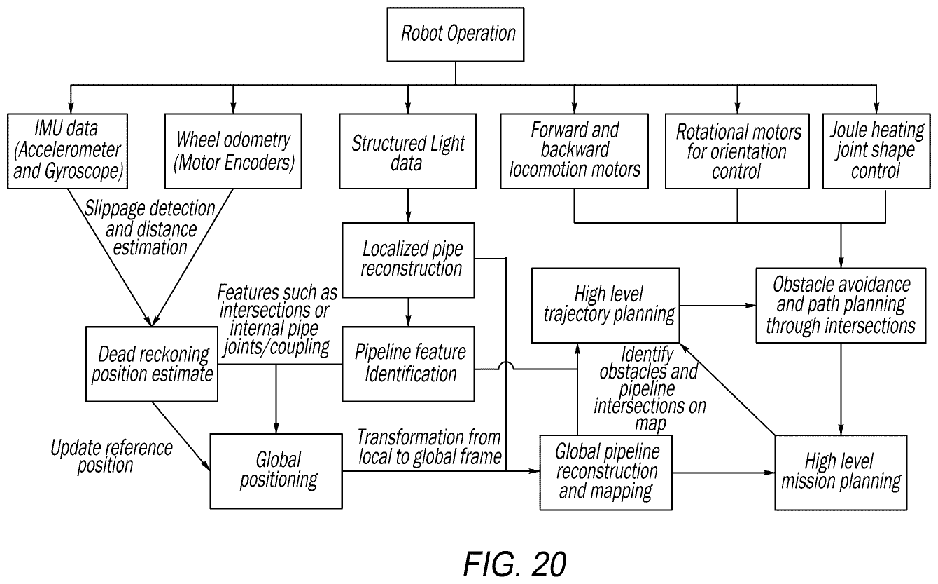

Integration of the inertial measurement unit and wheel odometry data to realize a synchronized sensor stabilization framework: The input from the IMU provides accurate data reconstruction in the presence of rotation and the absence of features by correcting the robotic platform rotation. Furthermore, the wheel encoder provides a precise robot location, which is beneficial for concurrent 3D data registration and defect measurement. The integrated information can provide a rough estimate of the pose of the sensors inside the pipe in terms of global positioning, which allows the SL sensing system to dynamically correct for changes in pose, resulting in a stabilized and accurate 3D reconstruction of wall profiles. FIGS. 13 and 20 summarize the main components of the integration approach.

Estimation of the reconstructed defect size information with uncertainty estimation: Based on the reconstructed 3D pipe cloud point, an intensity-based threshold searching method is applied to retrieve the reconstructed defect length and width, which is realized on the basis of the segmentation problem. Additionally, the depth of the defect is determined from the intensity of the extracted defect area.

A structured light (“SL”) sensor 79 includes a registration algorithm to allow the SL sensing system to dynamically correct for changes in pose due to robot movement in the pipe, resulting in a stabilized and accurate 3D reconstruction of wall profiles. The designed SL sensor is attached to a scanning platform that moves along a pipeline during the internal 3D inspection. Every frame from the sensor produces data for a sparse reconstruction of the pipe surface with a density that is dependent on the number of projected rings.

One such structured light-based sensing, calculation and reconstruction approach is disclosed in commonly owned U.S. Patent Publication No. 2024/0077426 entitled “Light-Based Inspection Tools for the Inspection of the Internal Surface of a Cylindrical Structure” which published to Deng, et al., on Mar. 7, 2024, and is incorporated by reference herein.

In an ideal experimental scenario, the axis of the sensor is aligned with the main axis of the pipe and always points in the direction of platform movement, which is defined as the z-axis. Therefore, the IMU-assisted robotic structured light sensing reconstructed 3D frames can be stacked sequentially by only adding a displacement in the z-direction that is dependent on the scanner speed at the time of acquisition. Experimentally, this assumption is not practical because it is difficult to maintain position of the sensor exactly at the center of the pipe in the forward direction. Additionally, the speed of the platform is difficult to keep constant due to multiple uncertainties such as imperfections in mounting of the sensor to the robot, vibration from the movement of the robotic platform, and slippage of the robot wheels.

Therefore, a holistic registration algorithm is desired to estimate both the orientation of the sensor and its real-time position inside the pipe in order to realize accurate 3D reconstruction. For a pipe environment with defects, the localization of the sensor can be divided into two interconnected tasks:
Global positioning: Localizing the identified damage with respect to the inspected pipe or pipeline network. The main information sources for global positioning in an underground environment are the inertial measurements, wheel odometry, and anchor points inside the pipe (joints, connection, mains, etc.).
Local positioning: Finding the geometrical transformation between consecutive frames from the sensor to reconstruct the surface, especially to characterize defects. Primary sources of information for local positioning include initial estimates of global positioning, refinements of 3D and 2D surface features, and known environmental constraints.

Simultaneous localization and mapping (“SLAM”) algorithms allow the incremental creation of maps using data from sensors while estimating real-time positions. For accurate global positioning in pipeline detection, the cylindrical nature of pipes is utilized as the basis for SL sensor-based localization. Additionally, encoder data from the robot can provide accurate estimations on how far inside the pipeline the robot is. After the global positioning is refined, the performance of the 3D reconstruction is related to the local positioning of the sensor as well.

In the present apparatus, information from wheel odometry and IMU are incorporated to estimate the speed and orientation of the sensor in real time, which are able to realize a more reliable local positioning. The data is then fed into a registration algorithm to provide an initial estimate of the sensor orientation and position inside the pipe. Following this, a RANSAC-assisted cylindrical fitting-based registration approach is utilized to provide high efficacy 3D point cloud registration to stabilize the sensor. This approach is preferred over using only features-based localization because it provides relatively accurate location and orientation estimation even when visual features, such as defects, are absent, which is common in plastic gas pipelines. With the stabilized sensor, the data registration is capable of calculating any shift and rotation of the sensor.

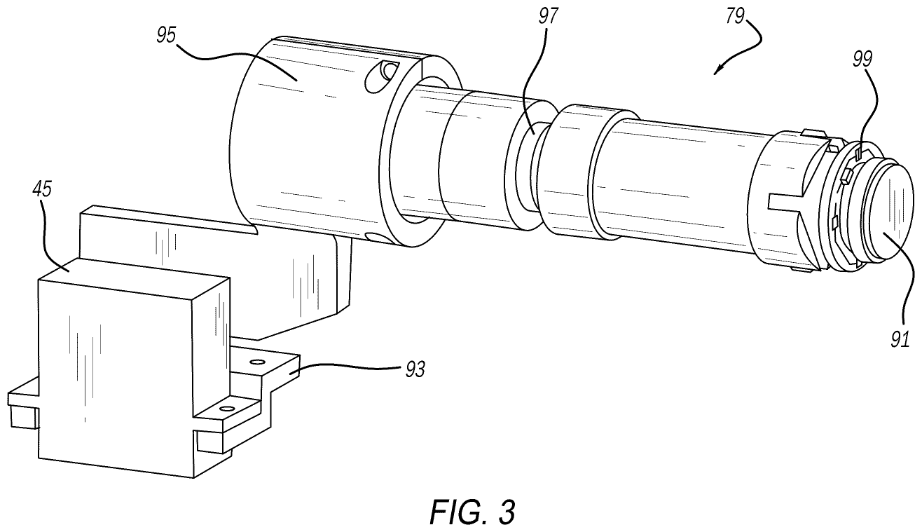

More specifically, the structured light sensor includes a projection module that projects a highly textured pattern, the camera that captures the deformations in the projected pattern, and a connected transparent glass tube for enabling the projection of the colored rings to the pipe walls, as shown in FIGS. 3, 8 and 9. The projector module includes a high-intensity light-emitting diode (“LED”), a collimation lens, a transparency slide, and a projection lens. The complementary metal-oxide-semiconductor (“CMOS”) camera is used to monitor the pipe surface and capture deformations in the projected rings. The 3D imaging reconstruction of the scanned object surface is the process of detecting, localizing, and matching the projected edges. In this automated software controlled process, the acquired image is converted to the polar domain to perform edge detection based on the predefined color coding of the slide pattern. The dark slits are separated while the edges are extracted for localization. With cleaning and filtering, the extracted edges of each acquired image are reconstructed into a cylindrical shape in the 3D domain, which provides a basis for point cloud registration between data frames.

Automated point cloud registration is next discussed. While the sensor is moving inside the pipe, each image frame produces a sparse reconstruction of the pipe surface with a density that is dependent on the number of projected rings. The 3D registration in this paper is categorized as a rigid registration problem, where two rigid frames need to be merged. The main fixed point cloud and the new points on the moving frame need to be merged with the main point cloud. Registration of these frames occurs where the moving frame is rotated and shifted to merge within the fixed frame.

The primary goal of the registration algorithm is to estimate the rigid geometrical transformation that registers the data from the moving frame to the data in the fixed frame. The geometrical transformation consists of rotation and translation in the 3D space. Therefore, the data in the moving frame DM is described by:

$$DF = [ R \vert T ] {D}_{M} \qquad ( 1 )$$

where R and T are the rotation matrix and the translation vector respectively, and DF is the data representation of the moving frame in the fixed frame coordinates. R is a 3×3 orthogonal matrix and T is 3×1 column vector.

A featureless-based 3D registration is set forth wherein the rotation matrix in Eq. (1) can be decomposed into its three main components:

$$R = {R}_{x} {R}_{y} {R}_{z} \qquad ( 2 )$$

where:

$${R}_{x} = ( \begin{matrix}1 & 0 & 0 \\ 0 & cos ( {ϕ}_{x} ) & - sin ( {ϕ}_{x} ) \\ 0 & sin ( {ϕ}_{x} ) & cos ( {ϕ}_{x} )\end{matrix} )$$

$${R}_{y} = ( \begin{matrix}cos ( {ϕ}_{y} ) & 0 & sin ( {ϕ}_{f} ) \\ 0 & 1 & 0 \\ - sin ( {ϕ}_{y} ) & 0 & cos ( {ϕ}_{y} )\end{matrix} )$$

$${R}_{z} = ( \begin{matrix}cos ( {ϕ}_{z} ) & - sin ( {ϕ}_{z} ) & 0 \\ sin ( {ϕ}_{z} ) & cos ( {ϕ}_{z} ) & 0 \\ 0 & 0 & 1\end{matrix} )$$

Rₓ, R_{y}, R_{z} are 3×3 rotation matrices that describe the rotation of the moving frame around x, y, and z axis, respectively, and φₓ, φ_{y}, φ_{z} are the corresponding rotation angles.

The translation vector also has three main components:

$$T = [ {T}_{x} , {T}_{y} , {T}_{z} ] \qquad ( 3 )$$

where Tₓ, T_{y}, T_{z} represent the displacement in the x, y, z directions, respectively. Since an infinite cylindrical surface is assumed, and with the assistance of inertial measurements, there is no need to estimate the rotation around the z-axis or the shift along the z direction. Therefore, in this example, the rigid transformation components are estimated through a cylindrical fitting, which is used to estimate Rₓ, R_{y}, and Tₓ, T_{y}.

To find the geometric transformation, the registration algorithm depends on both inertial measurements and the matching of the common features in the fixed and moving frames. The main framework of the proposed registration algorithm for sensor stabilization can be summarized in FIG. 13 with two main interconnected tasks: local positioning and global positioning. In this scheme, the use of a synchronized acquisition framework is realized with real-time 3D point cloud data which is assisted by IMU and wheel odometry data. Global positioning provides a rough estimate of the pose (position and orientation) of the sensors inside the pipe by using wheel odometry and inertial measurements. This data is fed to a registration algorithm to provide an initial guess about the pose of the sensors inside the pipe. The 3D information is then used to provide a more precise tuning. If defect features are found, the global position is updated and the data is registered; otherwise, the initial global position is used in addition to the constraints from the cylindrical 3D environment.

Cylindrical fitting is automatically performed by the software instructions. The 3D points from a sensor inside a pipe are assumed to belong to an arbitrary infinite cylinder (D_{arb}). This is a simplified assumption that ignores the existence of surface defects, which is a problem that will be accounted for separately. Therefore, in this method the prior pipe shape geometry is a basis to realize a non-feature-dependent 3D registration. A cylinder parallel to the z-axis that is centered around zero in the x-y plane is described as D. An infinite cylinder (D_{arb}) with an arbitrary orientation can be described as the cylinder D that is rotated by a rotation matrix R and shifted by a translation vector T_{Cyl}

$${D}_{arb} = RD + {T}_{Cyl} \qquad ( 4 )$$

where:

$$R = {R}_{x} {R}_{y} \qquad ( 5 )$$

$${T}_{Cyl} = [ {T}_{x} , {T}_{y} ] \qquad ( 6 )$$

From the above equations, the transformation is not a function of the shift and rotation around the z-axis; therefore, the number of parameters in the rigid transformation is reduced to φₓ, φ_{y}, Tₓ, and T_{y} only. A direct solution to fitting a cylinder to the point cloud can be found by minimizing the variance of the estimated radius of the pipe \hat{r}_{Cyl} from the estimated 3D points D. Therefore, the minimization problem is described by:

$$( {φ}_{x} , {φ}_{y} , {T}_{x} , {T}_{y} ) = arg min ( V ar ( {\hat{r}}_{Cyl} ) ) \qquad ( 7 )$$

and any point on the surface of estimated D satisfies

$${\hat{r}}_{Cyl} = \sqrt{{\hat{D}}_{{x}_{i}}^{2} + {\hat{D}}_{{y}_{i}}^{2}} , \qquad ( 8 )$$

$${\hat{r}}_{Cyl} = [ {r}_{Cyl 1} , {r}_{Cyl 2} , {r}_{Cyl 3} , … , {r}_{Cyln} ] \qquad ( 9 )$$

In this exemplary software, sensor characteristics are integrated into the 3D registration problem to improve the robustness of the fitting performance. The environment inside the pipe is accounted for by the calibrated structured light sensor enclosed by a cylinder with a radius R_{Cyl} while each projected ring by the SL projector is assumed to be an acute cone with the main axis direction described by a unit vector A^{→}_{Cyl}. In this environment, the camera is located at the origin (C=(0, 0, 0)) of the coordinate system and the camera is pointing along the z-axis. The projected ring is imaged by the camera to create a set of image points DC that can be represented by the camera ray (w^{→}).

The camera rays intersect with both the projected cone from the projector module and the surface of the bounding cylinder. Therefore, the intersection points belong to both the cylinder and the cone surfaces. With known cylinder parameters, the intersection between the camera ray and the cylindrical surface can be calculated with the substitution of the ray equation in the cylinder equation. Therefore, the cylinder orientation can be calculated by minimizing the difference between DC and D_{arb} which can be described by:

$$( {ϕ}_{x} , {ϕ}_{y} , {T}_{x} , {T}_{y} ) = arg min ( {‖ {D}_{arb} - {D}_{C} ‖}_{2}^{2} ) . \qquad ( 10 )$$

One source of error that affects the accuracy of the cylindrical fitting is the existence of artifacts on the pipe wall since the fitting process assumes an ideal cylindrical surface. The defect causes the fitting algorithm to be biased and results in an inaccurate estimation of the cylinder parameters; therefore, the concern is more prominent when having deep defects in the pipe wall. To reduce the effect of wall defects, the defects are assumed to be outliers that need to be identified and removed from the fitting problem.

Random sample consensus software instructions are applied. RANSAC is an iterative method that estimates the model parameters in the existence of outliers by separating them from inliers with repeated random sub-sampling. Therefore, all the defects are separated as they do not fit the cylindrical model that is assumed during the optimization process. The fitting process of simulation applies the input frame to the fitting process with a cylinder diameter of 6 inches (76.2 mm) and a wall defect of a depth of 10.16 mm, by way of nonlimiting example. The algorithm can successfully isolate the defect region from the rest of the cylindrical surface. After isolating the defect data, the cylindrical surface data is fitted and the rigid transformation parameters are calculated.

The inertial measurement unit is unable to provide an absolute 3D position of the sensor by itself, but it can provide linear acceleration, angular velocity and orientation information. Due to the integrative nature of the position calculation, the error in the position estimation accumulates over time, especially if small-size, low-end IMU sensors are employed. Therefore, only using accelerometer data for distance estimation is not a reliable solution for this use case. Accordingly, the present IMU also combines readings from a magnetometer and a gyroscope to estimate the orientation of the IMU in 3D space, which is used to estimate the rotation angle of the sensor inside the pipe. Gyroscope camera calibration is desired to estimate the rigid transformation between the camera and gyroscope readings. This enables a direct translation of the rotation in the gyroscope reading to a rotation in the camera/sensor frame.

Once the calibration parameters are known, the IMU data can be used to monitor the sensor orientation, which is further integrated for sensor orientation correction, with the following algorithm. In the beginning, a reference frame (frame 1) is marked and its orientation can be described by:

$${R}_{c 1} = {R}_{cal}^{T} {R}_{m 1} {R}_{cal} \qquad ( 11 )$$

where Rm is a rotation matrix for the change in rotation in the IMU frame, and R_{c} is a rotation matrix for the change in rotation in the camera frame. Rₘ₁ is the initial IMU frame, which gives the initial rotation in the camera frame R_{c1}. Any consecutive frame (frame i) orientation is described by:

$${R}_{c i} = {R}_{cal}^{T} {R}_{m i} {R}_{cal} \qquad ( 12 )$$

Relative rotation between the initial frame and the current frame i is given by:

$${R}_{cmi} = {R}_{c 1}^{T} {R}_{ci} \qquad ( 13 )$$

This can then be applied to correct the original data D_{ci} provided by the IMU to obtain the corrected data frame D_{cmi} to compensate for the actual sensor rotation as follows:

$${D}_{ci} = {R}_{cmi}^{T} {D}_{cmi} \qquad ( 14 )$$

Another set of sensors utilized for localization is the wheel odometers as an additional input to estimate the speed and position of the platform. The sensor position is estimated according to the number of wheel rotations at the ith frame wᵣ(i), and its diameter d. Therefore, the estimated instantaneous position at frame i relative to the initial location is given by:

$${T}_{od} ( i ) = {w}_{r} ( i ) π d \qquad ( 15 )$$

The estimated distance DISi between the ith and the previous frame is given as:

$${DIS}_{i} = {T}_{od} ( i ) - {T}_{od} ( i - 1 ) \qquad ( 16 )$$

In the experimental setup, a robotic platform is utilized to maneuver the structured light inside the pipeline. For linear movement inside the pipeline, the robot uses three pairs of wheels, with each set of wheels connected to a dedicated encoder. The robot with highlighted encoders is shown in FIG. 1, while the integrated SL sensor is attached at the side opposite to the Raspberry Pi. The robot is powered by two attached sets of 14.4 v LiPo batteries. These batteries provide the necessary power to the motors, structured light projectors, and other electronics, enabling them to operate untethered. The control board used for operation is a Raspberry Pi 4B, with GPIO pins used to control output to motors, read IMU and encoder data, and switch LEDs of the structured light sensor on and off. The Raspberry Pi allows for remote connection via Wi-Fi for remote controllability of the robot.

The robot is preferably driven by eight sets of N20 motors, with five of them having encoders to minimize packaging size. The middle three sets of motors are used for forwarding and backward directional movement inside the pipeline. These motors are connected to seven PPR magnetic encoders and are geared down at a ratio of 603:1, by way of nonlimiting example. This provides for a very high resolution on the rotation of the output shaft of the motor.

The use of three encoders improves the robustness of the data because the probability of three wheels slippage is lower than the probability of the slippage of a single wheel. In the present robot embodiment, the median distance between frames of the three encoders are used as the reference distance estimate for the entire robot. Utilizing the median can reduce effects from wheel slippage producing an artificial distance increase or from motor stalling decreasing the distance.

In conclusion, the present IMU-assisted robotic SL sensing system with enhanced registration and defect estimation is ideally suited for detection of obstructions, blockages, defects, irregularities, and intersections of underground or alternately above-ground pipes and conduits, especially those that are many meters, and in some situations, hundreds of meters long, such as sewer carrying pipes, fresh water carrying pipes, natural gas and petroleum carrying pipes, chemical liquid and gas carrying pipes, and exhaust pipes. The framework relies on a RANSAC-assisted cylindrical fitting registration algorithm in addition to inertial and odometry measurements for automatically obtaining the global and local positioning, which enables accurate 3D profiling and mapping. Instead of a direct matching of the point clouds, the present registration algorithm exploits the geometry of the pipe and certain sensor characteristics to enable accurate locational registration even in the presence of defects.

The input from IMU is beneficial for accurate data reconstruction in the presence of rotation and the absence of features by accurately correcting the rotation. The wheel encoder provides a precise robot location, which provides for concurrent 3D data registration and defect measurement. Furthermore, the present robot provides a robust and reliable 3D defect visual-based determination and reconstruction solution in terms of varying defect shape and depth within the pipe.

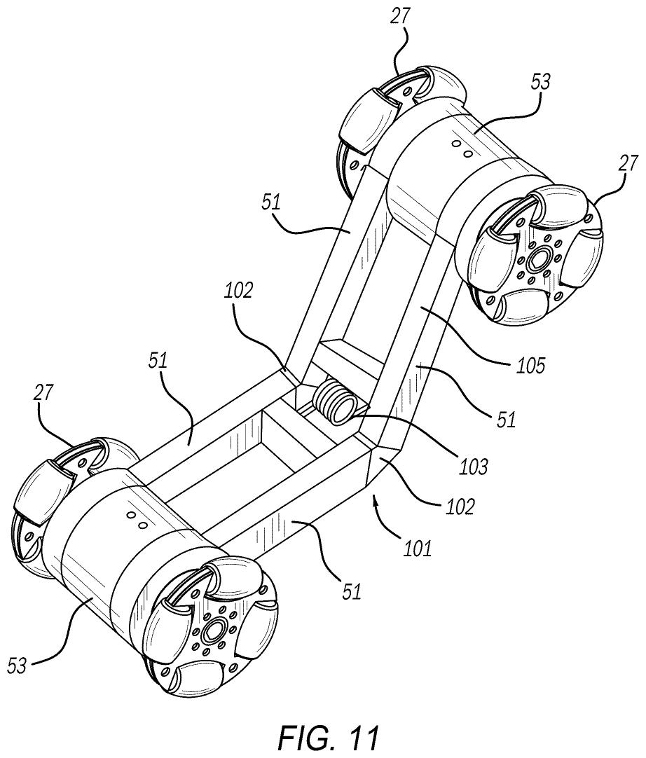

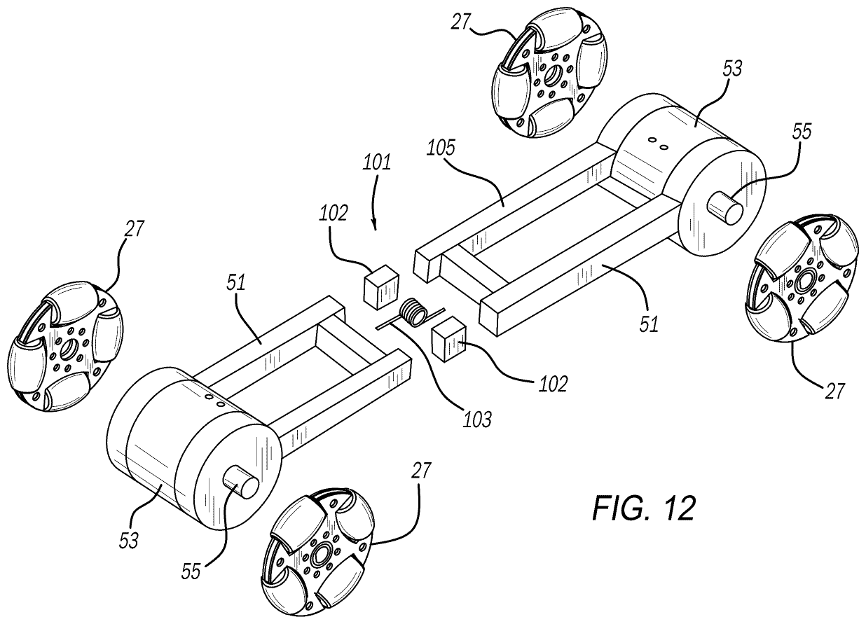

An alternate and optional feature for pipeline inspection robot 23 is shown in FIGS. 10-12. This configuration is the same as that previously described hereinabove, except that a sub-joint 101 is provided at an intermediate area of one or more sets of rails 51. Each sub-joint 101 includes polymeric couplings 102, a torsion spring 103 and electrically conductive traces 105. Alternately, a linear tension or leaf spring may be employed instead of the illustrated torsion spring.

Controllable stiffness and tunable sub-joints 101 are an option that may be employed with the present robot. Each coupling 102 is a thermoplastic material (such as 3D-printed conductive PLA, or CPLA) which can be used to modulate the stiffness and create temperature-tunable sub-joints. An electrical circuit extends from the battery to traces 105, which may be separate wires or the metal rails themselves, and then terminates at the sub-joint materials 102. A switch is selectively actuated by the onboard controller and its software instructions in order to flow electricity to the sub-joint materials 102 which then heats the materials, allowing them to soften and bend.

This allows offset orientation of the adjacent rails 51 thereby allowing them to fold thereby shrinking the lateral size of the robot, as can be observed by comparing FIG. 10 (nominally aligned rails) to FIG. 11 (folded rails 51 pivoted about subjoint 101). Turning off the current by the controller and its software thereafter cool and stiffen the subjoint material which causes the material to return to their original condition longitudinally re-aligning and straightening the adjacent rails. Joule-heating (namely, applying a current through the CPLA material) can be used to transition this material between a locked/rigid and flexible state.

This sub-joint bending allows the robot link to morph into multiple links when needed, for example, when it needs to pass tight turns or obstacles; but after the robot has passed such spots, the tunable links can return to the original rigid state for normal locomotion. The joule heated sub-joints 101 reconfigures the shape of the joints on the robot to different shapes instead of having a constant rigid W-like shape. This allows the robot to squeeze through tighter intersections, or to avoid obstacles better by morphing the shape of the robot to better pass through the obstructed area. It is alternately envisioned that multiple, longitudinally spaced apart sub-joints 101 may be incorporated between the intermediate rigid segments of each rail 51.

While various features of the present invention have been disclosed, it should be appreciated that other variations may be employed. For example, the linear springs may be replaced by electromagnetic actuators such as electric motor-driven balls and screws, but certain benefits may not be obtained. Additionally, alternate shapes, quantities and angles of the rails, joints, rotating plates and wheels may be provided, although some advantages may not be achieved. Alternately, rectangular cross-sectional conduits, such as for gas and air fluid flow, may be inspected instead of round cross-sectional, liquid fluid carrying pipes, and the pipes and conduits may be metal, polymeric, cement, ceramic, rubber or other materials. While it is preferred that the present robot be autonomously controlled by its onboard controller and software, some of its features may be employed with remotely controlled versions, and while it is preferred that the robot be untethers for longer pipeline movement, it is optionally envisioned that a mechanical cable may be attached to a trailing end thereof in the event that it needs to be manually extracted if stuck in a pipe, although some functional benefits may not be realized. Variations are not to be regarded as a departure from the present disclosure, and all such modifications are intended to be included within the scope and spirit of the present invention.

The invention claimed is:

1. A pipe inspection robot comprising:
multiple elongated rails connected by pivotable joints;
driving wheels located at at least some of the joints;
actuators mounted to the rails being configured to rotate the driving wheels; and
a linear spring coupled to an adjacent pair of the rails and spanning across one of the joints between the adjacent pair of the rails;
the linear spring biasing the rails toward a laterally enlarged orientation so that adjacent pairs of the joints are diagonally and oppositely offset angled from each other.

2. The robot of claim 1, further comprising:
at least one subjoint located within each rail between the joints containing the driving wheels;
the at least one subjoint allowing bending between adjacent rail segments when the at least one subjoint is in one condition, but providing a stiffened locking and straightening of the adjacent rail segments when in a second condition;
bending of the at least one subjoint being configured to allow the robot to pass a tight turn or obstacle within a pipe when moving along the pipe.

3. The robot of claim 2, further comprising:
an electrical circuit including a battery, traces and a switch, all being movable with the rails;
the at least one subjoint including a thermoplastic material that changes a softness state when an electrical current is supplied to the material via the electrical circuit.

4. The robot of claim 1, further comprising:
a camera movable with one of the rails;
an inertial measurement unit sensor movable with one of the rails;
a programmable controller movable with one of the rails;
an acceleration sensor movable with one of the rails;
an angular positioning sensor movable with one of the rails;
an encoder coupled to one of the actuators, which is an electric motor;
the camera, the inertial measurement unit sensor, the acceleration sensor, the angular positioning sensor, and the actuators being connected to the programmable controller;
a battery movable with one of the rails and supplying power to the actuators; and
the robot being untethered and autonomously drivable forward and backward.

5. The robot of claim 1, further comprising:
a programmable controller coupled to one of the rails;
a camera coupled to one of the rails and being connected to the programmable controller;
an accelerometer and a gyroscope coupled to one of the rails and being connected to the programmable controller;
a wheel encoder connected to the programmable controller;
the programmable controller using software programmed instructions, stored in non-transient memory, and input signals from at least the camera, the accelerometer, the gyroscope and the wheel encoder, to:
determine real-time location of the robot within an underground pipe;
control energization of the actuators to drive the robot forward and backward within the pipe;
determine if an irregularity or defect is observed within the pipe, obtain an image of the irregularity or defect, and match the location with the irregularity or defect; and
a communicator transmitting the image and the location to an external user display.

6. The robot of claim 1, further comprising:
at least one programmable controller;
a camera coupled to one of the rails and being connected to the programmable controller;
an accelerometer and a gyroscope coupled to one of the rails and being connected to the programmable controller;
a wheel encoder connected to the programmable controller;
the at least one programmable controller using software programmed instructions, stored in non-transient memory, and input signals from at least the camera, the accelerometer, the gyroscope and the wheel encoder, to:
determine real-time location of the robot within an underground pipe;
control energization of the actuators to drive the robot forward and backward within the pipe;
determine if an obstacle or intersection is observed within the pipe, obtain an image of the obstacle or intersection, and match the location with the obstacle or intersection; and
create a map of the pipe including the obstacle or intersection.

7. The robot of claim 1, further comprising:
a pair of the driving wheels being coupled to each of the joints via a laterally extending axle, one of the actuators rotating the axle for each of the joints to rotate the driving wheels, each pair of the driving wheels being drivably rotatable independently of the other pairs of the driving wheels in desired operating conditions; and
a battery being located between adjacent pairs of the driving wheels.

8. The robot of claim 1, wherein the actuators are electric motors, with an armature axis of each being longitudinally oriented between adjacent pairs of the joints.

9. The robot of claim 1, further comprising:
five or less supplemental rollers coupled to the periphery of each of the driving wheels, the supplemental rollers being free-spinning about axes oriented substantially perpendicular to a lateral pivot axis of the associated one of the joints;
the robot being autonomously driven forward and backward;
each of the driving wheels being rotated by its own, separately energizable one of the actuators; and
a lateral width of the robot being 88 mm or less.

10. A pipe inspection robot comprising:
multiple longitudinally elongated rails connected by pivotable joints;
a set of driving wheels located at at least some of the joints;
electric motors mounted to the rails being configured to rotate the sets of the driving wheels;
each of the electric motors including an armature, a centerline of which, is longitudinally elongated;
each set of the driving wheels being independently moveable, such that a speed of a first set of the driving wheels differs from a speed of a second set of the driving wheels in an operating condition, and a rotational direction of the first set of the driving wheels may differ from a rotational direction of the second set of the driving wheels in another operating condition; and
the joints are outwardly biased in alternating lateral directions away from a nominal longitudinal centerline of the robot.

11. The robot of claim 10, further comprising:
a camera movable with one of the rails;
an inertial measurement unit sensor movable with one of the rails;
a programmable controller movable with one of the rails;
an acceleration sensor movable with one of the rails;
an angular positioning sensor movable with one of the rails;
an encoder coupled to one of the actuators, which is an electric motor;
the camera, the inertial measurement unit sensor, the acceleration sensor, the angular positioning sensor, and the actuators being connected to the programmable controller;
a battery movable with one of the rails and supplying power to the actuators; and
the robot being untethered and autonomously drivable forward and backward.

12. The robot of claim 10, further comprising:
a programmable controller coupled to one of the rails;
a camera coupled to one of the rails and being connected to the programmable controller;
an accelerometer and a gyroscope coupled to one of the rails and being connected to the programmable controller;
a wheel encoder connected to the programmable controller;
the programmable controller using software programmed instructions, stored in non-transient memory, and input signals from at least the camera, the accelerometer, the gyroscope and the wheel encoder, to:
determine real-time location of the robot within an underground pipe;
control energization of the actuators to drive the robot forward and backward within the pipe;
determine if an irregularity, defect, obstruction or intersection is observed within the pipe, obtain an image thereof, and match the location therewith; and
a communicator transmitting the image and the location to an external user display.

13. The robot of claim 10, further comprising:
five or less supplemental rollers coupled to the periphery of each of the driving wheels, the supplemental rollers being free-spinning about axes oriented substantially perpendicular to a lateral pivot axis of the associated one of the joints;
the robot being autonomously driven forward and backward; and
a lateral width of the robot being 88 mm or less.

14. A pipe inspection robot comprising:
multiple longitudinally elongated rails connected by pivotable joints;
rotatable wheels located at the joints;
the joints being outwardly biased to create a substantially W-shape when moving within a pipe and being configured to cause the wheels of alternating of the joints to contact against opposite inner surfaces of the pipe;
actuators being configured to rotate at least some of the wheels;
a programmable controller coupled to one of the rails;
a camera coupled to one of the rails and being connected to the programmable controller;
an inertial measurement unit coupled to one of the rails and being connected to the programmable controller;
a wheel encoder connected to the programmable controller;
the programmable controller using software programmed instructions, stored in non-transient memory, and input signals from at least the camera, the inertial measurement unit sensor and the wheel encoder, to:
determine real-time location of the robot within an underground pipe;
control energization of the actuators to drive the robot forward and backward within the pipe;
determine if an irregularity, defect, obstruction or intersection is observed within the pipe, obtain an image thereof, and match the location therewith; and
a communicator configured to transmit the image and the location to an external user display.

15. The robot of claim 14, wherein the actuators are electric motors, with an armature axis of each being longitudinally oriented between adjacent pairs of the joints.

16. The robot of claim 14, wherein:
the robot is autonomously driven forward and backward;
the robot is untethered;
the robot is automatically reconfigurable for movement within and internal surface contact with different diameter pipes connected together underground; and
a lateral width of the robot is 88 mm or less.

17. The robot of claim 14, further comprising a remote controller receiving output data from the programmable controller moving with the robot, the remote controller automatically creating a map showing the pipe and showing the irregularity, defect, obstruction or intersection therein, relative to ground coordinate indicia.

18. The robot of claim 14, further comprising a remote controller receiving output data from the programmable controller moving with the robot, the remote controller automatically creating and displaying an image of the irregularity, defect or obstruction in the pipe.

19. A pipe inspection robot comprising:
multiple longitudinally elongated rails connected by pivotable joints;
rotatable wheels located at the joints;
the joints being outwardly biased to create a substantially W-shape when moving within a pipe and being configured to cause the wheels of alternating of the joints to contact against opposite inner surfaces of the pipe;
actuators being configured to rotate at least some of the wheels;
at least one subjoint located within a rail between the joints containing the wheels;
the at least one subjoint allowing bending between adjacent rail sections when the subjoint is in one condition, but providing an alignment of the adjacent rail sections when in a second condition; and
bending of the at least one subjoint being configured to allow the robot to pass a tight turn or obstacle within a pipe.

20. The pipe inspection robot of claim 19, further comprising:
an electrical circuit including a battery, traces and a switch, all being movable with the rails;
the at least one subjoint including a thermoplastic material that changes a softness state when an electrical current is supplied to the material via the electrical circuit.

21. The pipe inspection robot of claim 19, further comprising a programmable controller causing a temperature change of the at least one subjoint to achieve bending thereof.

22. The pipe inspection robot of claim 19, further comprising:
a camera movable with one of the rails;
an inertial measurement unit sensor movable with one of the rails;
a programmable controller movable with one of the rails;
the camera, the inertial measurement unit sensor, the electrical circuit, and the actuators being connected to the programmable controller;
a battery movable with one of the rails and supplying power to the actuators;
the robot being autonomously drivable forward and backward within the pipe which is underground; and
the at least one subjoint being substantially flush with an outside surface of the adjacent rail sections, and the at least one subject being configured without wheels thereon.

23. A method of using a robot to inspect an elongated conduit, the method comprising:
(a) energizing electric motors from a battery movable with the robot;
(b) independently rotating sets of driving wheels located at joints due to the energization;
(c) outwardly expanding links between the joints via linear tension springs affixed to adjacent pairs of the links and spanning across the joints therebetween;
(d) contacting alternate of the sets of the driving wheels against opposite inner surfaces of the conduit to cause movement of the robot within the conduit;
(e) generating first images of the inner surfaces of the conduit by a camera moving with the robot;
(f) sending signals to a programmable controller from an inertial measurement unit moving with the robot;
(g) sending signals to the programmable controller from a wheel encoder;
(h) determining a location of the robot within the conduit with the programmable controller based on at least one of the signals;
(i) controlling energization of the actuators to drive the robot forward and backward within the conduit;
(j) obtaining second images of an irregularity, defect, obstruction or intersection in the conduit, with the camera; and
(k) transmitting the first and the second images, matched with the location thereof, to an external user display.

24. A method of using a robot within an elongated conduit, the method comprising:
(a) energizing actuators to rotate driving wheels in order to longitudinally move the robot within the conduit;
(b) capturing images of an inner surface of the conduit by a camera moving with the robot;
(c) sending odometry signals to a programmable controller from a first sensor moving with the robot, the programmable controller moving with the robot;
(d) sending acceleration signals to the programmable controller from a second sensor moving with the robot;
(e) sending gyroscopic signals to the programmable controller from a third sensor moving with the robot;
(f) automatically determining a location of or a distance traveled by the robot within the conduit via the programmable controller based on at least one of the signals;
(g) automatically determining wheel slippage of the robot within the conduit via the programmable controller based on at least one of the signals; and
(h) automatically determining if the robot is stuck within the conduit via the programmable controller based on at least one of the signals.
